(19) United States
(12) Patent Application Publication
(10) Pub. No.: US 2009/0255794 A1
(43) Pub. Date: Oct. 15, 2009

(54) Switching Device with a Heat Pipe

(75) Inventors: Ralf-Peter Kurth, Schorfheide (DE); Michael Kleineberg, Berlin (DE); Clemens Rüthnick, Kleinmachnow (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munchen (DE)

(21) Appl. No.: 11/817,739

(22) PCT Filed: Feb. 23, 2006
(86) PCT No.: PCT/EP2006/060231

§ 371 Date: Nov. 5, 2008

(30) Foreign Application Priority Data
Mar. 3, 2005 (DE) 10 2005 011 405.9

(51) Int. Cl. H01H 1/62

(52) U.S. Cl. 200/289

(57) ABSTRACT

A device for interrupting an electrical alternating current, which is driven by a high voltage, includes contact pieces that are connected to conductors and placed inside a contact housing. The conductors are guided in an at least partially displaceable manner, and the contact pieces can be transferred from a contact position into a non-contact position by means of a drive and of drive kinematics. The aim of the invention is to provide a switching device of the aforementioned type with which even higher currents can also be controlled. To this end, a heat tube with a fluid-tight heat tube housing is provided, which has an evaporation area, a condensation area, and a capillary structure extending between the evaporation area and the condensation area and being thermally coupled to both of them. The heat tube has a heat transfer means, and the evaporation area is connected in a heat-conducting manner to one of the conductors or to one of the contact pieces.

The invention relates to an apparatus for interrupting an electrical alternating current driven by a high voltage with contact pieces, which are connected to conductors and are arranged in a contact housing, the conductors being guided so as to be at least partially movable, and the contact pieces being capable of being moved over from a contact position into an isolated position by means of a drive and drive kinematics.

Such an apparatus is already known, for example, from EP 0 606 265 B1. The apparatus disclosed therein is designed for interrupting an electrical current which is driven by a high voltage. In this case, the apparatus has a conductor path which is routed via contact pieces. The contact pieces are opposite one another in the longitudinal direction and, by introduction of a switching movement, can be moved over from a contact position in which the contact pieces are in contact with one another to an isolated position, in which the contact pieces are isolated from one another. In this case, the contact pieces are arranged in a vacuum interrupter, in which a vacuum for quenching an arc drawn during isolation of the contact pieces prevails. One of the contact pieces is held fixed in position by means of a fixed contact conductor, which is fixedly connected to the vacuum housing. In this case, the fixed contact conductor passes through the vacuum housing and is electrically conductively connected to an input connection via further conductors. The movable contact piece is attached to the end of a switching rod, which is likewise arranged in the vacuum housing and is guided such that it can move longitudinally. Coupling means in the form of a flexibly elastic strip are arranged between an outgoing connection and the switching rod for electrical connection purposes. A factor limiting the performance capacity of previously known apparatuses is the development of heat at the conductors of the current path which occurs in particular in the case of high currents. Such heat development can be observed in particular at the contact faces of the contact pieces, but also at the flexible strip, which has a smaller conductor cross section in comparison with the remaining conductors of the conductor path.

DE 197 17 235 A1 has disclosed a heat pipe which has a substantially hollow-cylindrical heat pipe housing, which has an evaporation region at one of its ends and a condensation region at its other end. A capillary structures extends within the heat pipe housing between the evaporation region and the condensation region. Furthermore, the heat pipe has a heat transport medium in the form of a fluid, which is sealed off from the outer atmosphere by the heat pipe housing. Before the heat pipe housing is sealed off, the gas phase of the heat transport medium is evacuated, with the result that the pressure prevailing in the heat pipe housing is approximately equal to the vapor pressure of the heat transport medium at the respectively prevailing temperature. In other words, the gas phase, which virtually exclusively comprises heat transport medium, is in equilibrium with the liquid phase of the heat transport medium. If one side of the heat pipe is subjected to a higher temperature than its other side, in the heated evaporation region this results in evaporation of liquid and in transport of the vapor towards the condensation region, which is colder than the evaporation region and brings about condensation of the heat transport medium. In this case, heat is output to the external environment. Heat pipes have until now mainly been used in the sector of computer technology.

The object of the invention is to provide an apparatus of the type mentioned at the outset with which it is possible to control even relatively high currents.

The invention achieves this object by a heat pipe having a fluid-tight heat pipe housing, which has an evaporation region, a condensation region and a capillary structure, which extends between the evaporation region and the condensation region and is thermally coupled thereto, the heat pipe housing having a heat transport medium, and the evaporation region being thermally conductively connected to one of the conductors or one of the contact pieces.

According to the invention, the heat is dissipated by a heat pipe which has until now only been known from the sector of computer technology at the points which are characterized by a particularly high degree of heat development. In this case, the heat pipe acts as a rapid heat conductor, with which the heat is transported away from the critical points quickly and is output via the condensation region to any external environment, such as atmospheric air, for example. The heat transport is based on the evaporation of the heat transport medium in the evaporation region, heat being drawn from the conductor, which makes contact with the vaporization region of the heat pipe, owing to the required evaporation enthalpies. The heat transport medium tends in the gas phase to pass to the condensation region, which has a lower temperature in comparison with the evaporation region. Owing to the saturated vapor phase, condensation of the heat transport medium takes place at the condensation region and therefore an output of evaporation enthalpy in the form of heat takes place. The condensed heat transport medium then begins on its return path to the evaporation region owing to the capillary effect of the capillary structure, which extends between the evaporation region and the condensation region. In this way, a circuit is produced which makes possible effective heat transport by means of evaporation and condensation of heat transport medium. It has been shown that the heat pipe designed for the computer industry can unexpectedly also be used for cooling components which are warming up in the high-voltage sector and in particular in the low-voltage sector, i.e. at voltages of from 1 kV to 52 kV. In this context, it is possible within the scope of the invention to use virtually any desired design of the heat pipe.

In accordance with an expedient development of the apparatus according to the invention the conductor has a cutout, into which the heat pipe extends partially. The heat pipe is therefore arranged with its evaporation region in the cutout. The cutout is expediently arranged in the vicinity of those regions in which a particularly high thermal load arises. These are, as has already been mentioned, regions with a constricted conductor cross section in comparison with the remaining conductors.

In accordance with a development in this regard, the cutout is arranged in a contact conductor, which passes through the contact housing and bears one of the contact pieces at its contact piece end arranged in the contact housing, the condensation region of the heat pipe being arranged outside of the contact housing. The cutout therefore extends through the contact conductor into the contact housing and is therefore arranged in the immediate vicinity of the contact pieces, at whose contact face a high thermal load results owing to an unideally flat resting position.

The heat produced can thus be dissipated efficiently out of the contact region by means of the heat pipe.

In accordance with a further development in this regard, the contact conductor is fixedly connected to the contact housing. In this development, only one of the two contact pieces is held movably, while the contact piece associated with it is arranged fixed in position in the contact housing. Owing to the arrangement of the heat pipe in the stationary contact conductor, a movement of the heat pipe is avoided.

In accordance with a further variant, the conductors have a movably guided switching rod, which is connected to a moving contact piece of the contact pieces, and an outgoing connection, which is electrically connected to the switching rod via coupling means, the evaporation region being arranged on or in the outgoing connection. In accordance with this expedient development, the heat pipe is arranged in the vicinity of the coupling means, at which constrictions of the conductor cross section and therefore high degrees of heat development during current flow generally occur.

It is naturally possible within the contact of the invention for the apparatus to have two or even more heat pipes. For example, one heat pipe is thus arranged in the stationary contact conductor, while the other heat pipe is arranged at the outgoing connection.

In accordance with an expedient development in this regard, the coupling means have a flexibly elastic strip. Other coupling means which can likewise be used in the context of the invention are, for example, a sliding contact or a roller contact, at which a constriction of the conductor cross section can likewise be observed. The flexible strip is, for example, connected to the connection piece by means of a screw connection, the heat pipe expediently being arranged in the immediate vicinity of the flexible strip—for example only separated from the flexible strip via a thin conductor layer—in a cutout, which has been introduced into the outgoing connection piece.

In accordance with an expedient development, the condensation region makes contact with a heat sink. Owing to the arrangement of a heat sink at that region of the heat pipe which emits the heat, the cooling power of the heat pipe is increased considerably. In this way, a further reduction in the operating temperature of the current path of the apparatus is made possible, which current path is formed from the conductors and the contact pieces.

Advantageously, the contact piece is arranged in a grounded electrically conductive switch housing. The switch housing surrounds, for example, three contact arrangements, which are each arranged in one phase of an AC system. In this case, each contact arrangement comprises two contact pieces associated with one another. These contact pieces are opposite one another, for example, in a longitudinal direction, one of the contact pieces being fixedly connected to the switch housing, while the other is guided in said switch housing such that it can move longitudinally.

In accordance with an expedient development in this regard, the conductors have a busbar, which extends, by means of a leadthrough, through a housing wall, which is at ground potential during operation of the apparatus, the busbar having, on its side remote from the contact housing, a cutout, in which part of the heat pipe is arranged. As has already been mentioned, it is also possible within the context of the invention to use a plurality of heat pipes at the same time in or on the apparatus. In accordance with this development, one or the heat pipe is arranged outside of a module area of a switchgear assembly or else even completely outside the switchgear assembly, which comprises, for example, a sheet metal housing which is at ground potential.

As a deviation from this, the contact housing is arranged in an electrically nonconductive insulating housing. Such an insulating housing is, for example, closed on all sides or is hollow-cylindrical or tubular, fixing means for holding the contact housing being provided in the insulating housing. It is naturally also possible within the context of the invention to cast the contact housing in an insulating housing in a plastic, with the result that an air gap between the contact housing and the insulating housing is avoided.

Advantageously, the contact housing is a vacuum tube, in which a vacuum is applied. In this development, the vacuum acts as a quenching medium for quenching an arc drawn on isolation of the contact pieces. The heat pipe is suitable in particular in the context of the use of vacuum interrupters or vacuum tubes since the output of heat is made more difficult in the interior of the tube. A heat transfer by means of convection is not possible in the vacuum. In the case of the vacuum tube, a heat flow can be realized merely via the thermally conductive connection of the conductors or by means of thermal radiation.

Expediently, the heat transport medium has a liquid phase and a vapor phase, the pressure within the heat pipe housing being equal to the vapor pressure of the liquid phase. In other words, the entire gas phase within the heat pipe housing comprises virtually exclusively particles of the heat transport medium, with the result that the vapor phase is a so-called saturated vapor phase, which is in equilibrium with the liquid. Owing to heating of the evaporation region, the equilibrium is disrupted and the heat transport already described sets in without any delay.

Further expedient configurations and advantages are the subject matter of the description below relating to exemplary embodiments of the invention with reference to the figures of the drawing, in which identical reference symbols refer to functionally identical components and

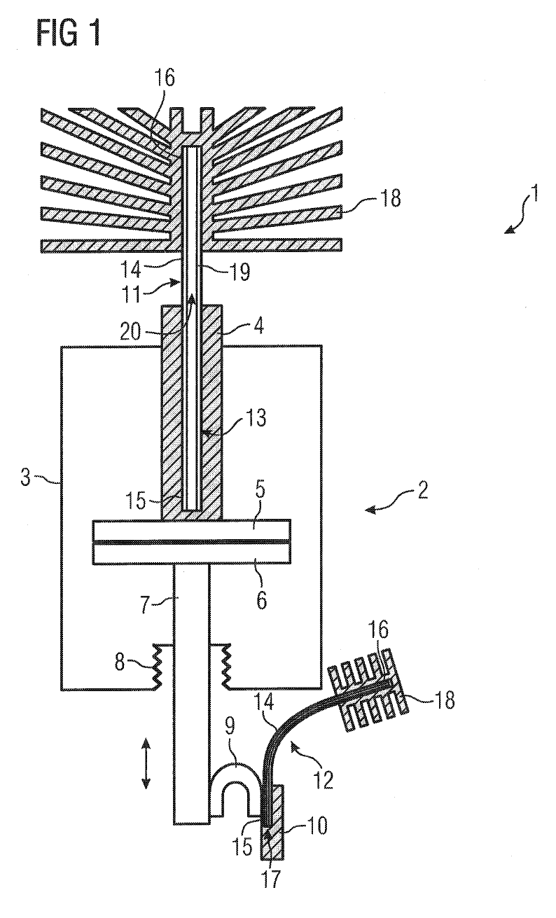

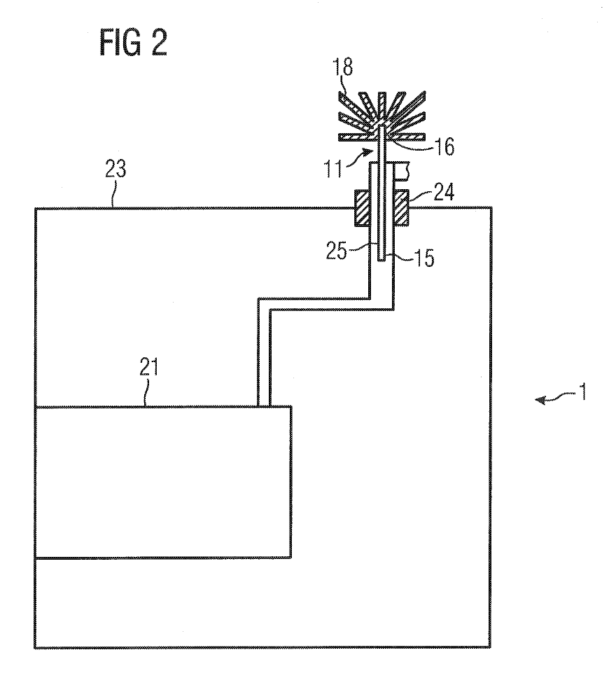

FIG. 1 shows an exemplary embodiment of the apparatus according to the invention, and FIG. 2 shows a further exemplary embodiment of the apparatus according to the invention.

FIG. 1 shows an exemplary embodiment of the apparatus 1 according to the invention in a schematic illustration. The apparatus 1 shown comprises a vacuum interrupter 2, which is known per se, having a vacuum housing 3 and a stationary fixed contact 5, which is fixedly connected to the vacuum housing 3 via a fixed contact bolt 4, a moving contact 6 lying opposite said fixed contact 5 in a longitudinal direction. The moving contact 6 is attached to a switching rod 7, which is guided such that it can move longitudinally, with the result that, owing to an excursion movement of the switching rod 6 in the direction indicated by the arrows, the moving contact can be moved over from a contact position, in which it bears against the fixed contact 5, into an isolated position, in which it is arranged at a distance from the fixed contact 5. The switching rod 7 is connected to the vacuum housing 3 in such a way that it can move longitudinally via a metal bellows 8.

A vacuum is applied in the vacuum housing 3, in which vacuum an arc, which is drawn on isolation of the contact pieces 5 and 6, is quenched. The switching rod 7 is connected to an outgoing connection 10 via a flexible strip 9, which outgoing connection 10 is arranged fixed in position in an insulating housing (not illustrated in the figures). The insulating housing surrounds in each case one vacuum tube, with the result that a single-pole-encapsulated switch having three switch poles is provided by means of three apparatuses 1. In this case, each pole is associated with one phase of a three-phase AC system.

In the contact position of the fixed contact 5 with the moving contact 6, despite the high contact-pressure force provided by a contact spring, current transitions at points result between the two contact pieces, resulting in an effective current cross-section constriction. In other words, in the event of a current transition between the contact pieces 5 and 6, a high degree of heat development results, which heat can only be output towards the outside in the form of heat conduction via the fixed contact bolt 4 and the switching rod 7 and in the form of thermal radiation, in the vacuum owing to the lack of convection.

A further cross-section constriction is experienced by the current at the flexible strip 9. Here, too, an increased level of heat development takes place, as a result of which the current-loading capacity of the vacuum interrupter 2 and therefore of the apparatus 1 is limited.

In order to improve the dissipation of heat from the apparatus 1, heat pipes 11 and 12 are provided. The heat pipe 11 is arranged in a cutout 13, which reaches far into the fixed contact bolt, and has a fluid-tight heat pipe housing 14, which has a vaporization region 15, which faces the fixed contact 5, and a condensation region 16 remote therefrom. The same applies to the heat pipe 12, which is arranged with its vaporization region 15 in a cutout 17 of the outgoing connection piece 10 in the vicinity of the flexible strip 9.

The condensation region 16 of each heat pipe 11 or 12 is equipped with a heat sink 18, which is provided with cooling ribs so as to increase its heat exchange area and consists, for example, of a thermally conductive metal. The fluid-tight heat pipe housing 14 comprises, for example, a gas-tight copper pipe, on whose inside a capillary structure 19 extends between the vaporization region 15 and the condensation region 16. In this case, the capillary structure 19 surrounds a clear cavity 20. The heat pipe housing 14 of the respective heat pipe 11 or 12 is filled with a heat transport medium (not illustrated in the figures), which has a liquid phase or a vapor phase, the internal pressure of the heat pipe substantially corresponding to the vapor pressure of the heat transport medium. In other words, the vapor phase within the heat pipe housing has substantially no foreign gases. At a uniform temperature of the heat pipe, the phases of the heat transport medium are in equilibrium with one another.

During operation of the apparatus 1, the temperature of the vaporization region 15 increases to above the temperature of the condensation region 16. Vaporization of the heat transport medium which is transported, as a gas, through the clear cavity 20 to the condensation region 16, i.e. the cooler region, results. Owing to the lower temperature, condensation of the vaporous heat transport medium results there, the resulting liquid being transported back to the vaporization region via capillary forces of the capillary structure 19. The heat enthalpy consumed in the evaporation is in this way effectively output to the outer region of the condensation region 16. Owing to the heat sink 18, the temperature difference between the vaporization region 15 and the condensation region 16 and therefore the dissipation of heat by the heat pipe 11 or 12 is increased.

FIG. 2 shows a further exemplary embodiment of the apparatus 1 according to the invention in a schematic illustration. In the exemplary embodiment, the vacuum interrupter shown in FIG. 1 with two further vacuum interrupters is arranged in a switch housing 21 which is at ground potential, the fixed contact bolts (likewise not illustrated in FIG. 2) each being connected to a busbar 22. The view in FIG. 2 merely shows one of these busbars 22.

The busbar 22 is arranged in a further switching housing 23, which is likewise at ground potential. A leadthrough 24 is used for leading out of the switch housing 23 in an insulated fashion. Leadthroughs are known as such, with the result that no further details need to be given at this point with regard to their construction. Reference is merely made to the fact that the leadthrough 24 has a nonconductive insulating body consisting of cast resin and is fixed to the switch housing 23 via the insulating body. The busbar 22 has a cutout 25, into which a heat pipe 11 partially extends, the condensation region 16 and the heat sink 18 of the heat pipe 11 being arranged outside of the switch housing 23. During operation of the apparatus 1, heat is transported via the thermally conductive busbar 22 to the vaporization region 15 of the heat pipe 11 and, from there, is output in accelerated fashion via the heat sink 18 to the external atmosphere.

1-12. (canceled)

13. An apparatus for interrupting an electrical alternating current driven by a high voltage, comprising:
a contact housing;
contact pieces movably disposed in said contact housing between a contact position and an open position;
conductors connected to said contact pieces and being guided to be at least partly movable;
a heat pipe with a fluid-tight heat pipe housing and defining an evaporation region, a condensation region, and a capillary structure extending between said evaporation region and said condensation region and being thermally coupled therewith; and
a heat transport medium in said heat pipe housing; and
wherein said evaporation region is thermally conductively connected to one of said conductors or one of said contact pieces.

14. The apparatus according to claim 13, wherein one of said conductors is formed with a cutout, and said heat pipe extends partially into said cutout.

15. The apparatus according to claim 14, wherein said cutout is formed in a contact conductor passing through said contact housing and bearing one of said contact pieces at a contact piece end thereof inside said contact housing, and wherein said condensation region of said heat pipe is disposed outside said contact housing.

16. The apparatus according to claim 15, wherein said contact conductor is fixedly connected to said contact housing.

17. The apparatus according to claim 13, wherein said conductors include a movably guided switching rod connected to a moving contact piece of said contact pieces and an outgoing connection electrically connected to said switching rod via coupling means, and said evaporation region is formed in or at said outgoing connection.

18. The apparatus according to claim 17, wherein said coupling means includes a flexibly elastic strip.

19. The apparatus according to claim 13, which comprises a heat sink in contact with said condensation region.

20. The apparatus according to claim 13, wherein said contact housing is disposed in an electrically conductive, grounded switch housing.

21. The apparatus according to claim 20, wherein said conductors have a busbar extending, by way of a leadthrough, through a housing wall, which lies at ground potential during an operation of the apparatus, said busbar, on a side thereof remote from said contact housing, being formed with a cutout receiving therein a part of said heat pipe.

22. The apparatus according to claim 13, wherein said contact housing is disposed in an electrically nonconductive insulating housing.

23. The apparatus according to claim 13, wherein said contact housing is a vacuum tube with an evacuated interior.

24. The apparatus according to claim 13, wherein said heat-conducting medium has a liquid phase and a vapor phase, and wherein a pressure within said heat pipe housing is equal to a vapor pressure of the liquid phase.
